(19) United States
(12) Patent Application Publication
(10) Pub. No.: US 2008/0064844 A1
(43) Pub. Date: Mar. 13, 2008

(54) Isocyanate terminated polycaprolactone polyurethane prepolymers

(76) Inventors: Phaniraj T. Nagaraj, Naugatuck, CT (US); Ronald O. Rosenberg, Orange, CT (US)

Correspondence Address: Michael P. Dilworth, Esq.;Chemtura Corporation, 199 Benson Road, Middlebury, CT, 06749, US

(21) Appl. No.: 11/520,197

(22) Filed: Sep. 13, 2006

(51) Int. Cl. C08G 18/10

(52) U.S. Cl. 528/59

(57) ABSTRACT

Disclosed are improved isocyanate-terminated polycaprolactone polyurethane prepolymers comprising the reaction product of toluene diisocyanate and polyol compositions. Polyurethane elastomers with good physical and dynamic properties can be obtained by reacting the isocyanate-terminated polycaprolactone prepolymers of the invention with an amine chain extender.

### FIELD OF THE INVENTION

The present invention is directed to a polyurethane elastomer, more specifically, the present invention is directed to a polyurethane elastomer prepared from an isocyanate-terminated polycaprolactone polyurethane prepolymer which can be easily cured to a solid polyurethane elastomer by the reaction of the prepolymer with an amine chain extender.

### BACKGROUND OF INVENTION

Polyurethane elastomers are frequently used in applications that require a combination of physical, chemical and dynamic properties such as good abrasion resistance, tear strength and low hysteresis. Prepolymers from toluene diisocyanate (TDI) and a variety of polyols may be cured with aromatic diamine curatives such as methylene bis(orthochloroaniline) (MBCA) available as Vibracure® A133, from the Chemtura Corporation, to yield such elastomers.

The isocyanate terminated urethane prepolymers are known in the art and can be formed by first reacting a polyol with a molar excess of an organic diisocyanate monomer to form a prepolymer having terminal isocyanate groups, and then optionally removing the residual excess diisocyanate monomer. Examples of such polymers are described in U.K. Patent No. 1,101,410 and in U.S. Pat. Nos. 5,703,193, 4,061,662, 4,182,825, 4,385,171, 4,888,442 and 4,288,577, all of which are incorporated herein by reference.

Prepolymers can be based on toluene diisocyanate and a variety of polyols including polyethers, polyesters and polycaprolactones and the like. Examples of commercial prepolymer products are the Adiprene/Vibrathane prepolymers from Chemtura, including: Vibrathane B602, 3.1% NCO prepolymer from Polytetramethylene ether glycol (PTMEG, e.g. Terathane from Invista); Vibrathane 8080, 3.3% NCO prepolymer from ethylene propylene adipate polyester (e.g. Fomrez from Chemtura Corporation); and Vibrathane 6060, 3.35% NCO prepolymer from polycaprolactone (e.g. Tone from Dow Chemical).

Desired physical, chemical and dynamic polyurethane properties can be obtained by the use of various components as known in the art. For example, the isocyanate (NCO) content of a prepolymer generally governs the Shore A hardness of the elastomer obtained from that prepolymer with a given curative.

The use of prior art TDI terminated polycaprolactone prepolymers cured with aromatic diamine curatives such as MBCA gives softer elastomers with lower physical properties than prepolymers synthesized from TDI and other polyols, such as, for example, polytetramethylene ether glycol (PTMEG) or adipate polyester. The use of Vibrathane 6060, a 3.35% NCO, TDI terminated polycaprolactone prepolymer without low molecular weight glycols, manufactured by Chemtura Corporation cures to a Shore A hardness of only 62A with MBCA, whereas, the use of Vibrathane 8080, a 3.3% NCO, TDI terminated polyester prepolymer manufactured by Chemtura Corporation cures to 80A with MBCA. Further examples, such as, Vibrathane B602, a 3.1% NCO, TDI terminated polyether prepolymer manufactured by Chemtura Corporation cures to 82A with MBCA.

As such, it would be desirable to impart higher hardness and physical properties to elastomers from TDI terminated polycaprolactone prepolymers.

### SUMMARY OF INVENTION

The present invention relates to a prepolymer composition comprising the reaction product of:
a) at least one organic polyisocyanate;
b) at least one polycaprolactone-based polyol possessing a number average molecular weight of from about 300 to about 10,000;
c) at least one glycol possessing a number average molecular weight of not greater than about 300; and, optionally,
d) at least one additional polyol.

The present invention provides isocyanate-terminated polycaprolactone polyurethane prepolymers that can be easily cured to foams and solid elastomers having improved physical and dynamic properties by the reaction of the prepolymer with an amine chain extender.

The present invention further provides formulations for manufacture of elastomers that can be used in areas requiring good compression set resistance, rebound resilience, tear strength and dynamic properties such as seals, gaskets, wheels, tires, rolls, mining screens and belting applications.

Thus, the polyurethane elastomers prepared herein have improved physical and dynamic properties vs. elastomers based solely on polycaprolactone polyols without the low molecular weight glycols.

### DETAILED DESCRIPTION OF THE INVENTION

Unlike TDI terminated polyether or polyester prepolymers, it has now been surprisingly found that the TDI terminated polycaprolactone prepolymers behave very differently depending on the presence of a low molecular weight glycol. This behavior has been observed both in conventional TDI terminated polycaprolactone prepolymers (i.e., those in which the free unreacted TDI monomer is not removed) and in low free monomer TDI terminated polycaprolactone prepolymers. It has also been surprisingly found that TDI terminated polycaprolactone prepolymers comprising low molecular weight glycols improve the dynamic performance of the final elastomer.

The prepolymer composition is prepared by the reaction of (a) at least one organic polyisocyanate, with (b) at least one polycaprolactone-based polyol and (c) at least one low molecular weight glycol, and optionally, additional polyol (e). The additional polyol(s) (e) typically possess a molecular weight above about 300, e.g., polyadipate ester polyols (e.g. Fomrez polyols from Chemtura Corp.), polyether polyols (e.g. Terathane polyols from Invista or Poly G polyols available from Arch Chemicals), or polycarbonate polyols (e.g. Desmophen 2020E polyol available from Bayer), and the like.

Suitable additional polyols (e) include polyetherester polyols, polyesterether polyols, polybutadiene polyols, acrylic component-added polyols, acrylic component-dispersed polyols, styrene-added polyols, styrene-dispersed polyols, vinyl-added polyols, vinyl-dispersed polyols, urea-dispersed polyols, polyoxyalkylene diols, polyoxyalkylene triols, polytetramethylene ether glycols, and the like, all of which possess at least two hydroxyl groups.

The polyisocyanates of the present invention include any diisocyanate that is commercially or conventionally used for production of polyurethane foam. In one embodiment of the present invention, the polyisocyanate can be an organic compound that comprises at least two isocyanate groups. The polyisocyanate can be aromatic or aliphatic.

According to one specific embodiment of the invention, toluene diisocyanate (TDI) monomer is reacted with a blend of high molecular weight polycaprolactone polyol and low molecular weight glycol, optionally followed by an operation in which the excess TDI monomer is removed to produce a prepolymer having unreacted TDI content below 2% by weight, and in another embodiment of the invention, below 0.5% by weight and in still another embodiment below 0.1% by weight.

Illustrative toluene diisocyanates (TDI) of the present invention include two main isomers, i.e., 2,4- and 2,6-toluene diisocyanate. Commercially TDI is found as approximately 65:35, 80:20 or 99:1 isomer mixes of 2,4- and 2,6-toluene diisocyanate from Bayer, BASF, Lyondell, Borsodchem, Dow Chemical and other suppliers.

According to the present invention, equivalent weight means the molecular weight divided by the number of functional groups (such as isocyanate groups, hydroxyl groups or amine groups) per molecule. According to this invention, molecular weight or M.W. means number average molecular weight. Equivalent weight or E.W. means number average equivalent weight.

In one embodiment of the invention, the high molecular weight polyols, i.e., polycaprolactone (PCL) polyols possess a number average molecular weight of at least about 300, and are used to prepare the prepolymer of the instant invention. According to another embodiment of the present invention, the polycaprolactone polyols possess a molecular weight of about 650 to about 4000, and possess a molecular weight of about 650 to about 3000 in another embodiment of the invention. However, the molecular weight may be as high as about 10,000 or as low as about 300.

According to one embodiment of the invention, the polycaprolactone polyols may be represented by the general formula:

H(OCH₂CH₂CH₂CH₂CH₂O)ₘOIO(OCH₂CH₂CH₂CH₂CH₂O)ₙH;

wherein I is a hydrocarbon moiety or an organic moiety with ether or ester linkages and m and n are integers large enough that the polycaprolactone polyol has a number average molecular weight of at least about 300 to about 10,000. The polycaprolactone polyols can be prepared by addition polymerization of epsilon-caprolactone with a polyhydroxyl compound as an initiator. Diethylene glycol (DEG), Trimethylolpropane (TMP), Neopentyl glycol (NPG) or 1,4 Butanediol (BDO) are suitable examples of initiators. Higher molecular weight polyols such as polytetramethylene ether glycol (PTMEG) of 250-2900 molecular weight may also be used as initiators. According to one embodiment of the invention, the PCL polyols are those based on DEG, BDO or NPG initiator. Such polyols are available as Tone polyols from Dow Chemical, CAPA polyols from Solvay and Placcel polyols from Diacel. In an embodiment of the present invention, the hydroxyl functionality of the polyols is from about 2 to about 3.

The total polyol portion of the instant invention is a combination of high molecular weight polyol as previously described and a low molecular weight glycol. An aliphatic glycol is the preferred low molecular weight glycol. Suitable aliphatic glycols include: ethylene glycol or the isomers of propanediol, butanediol, pentanediol or hexanediol. In one particular embodiment of the invention, low molecular weight glycols are 1,3 butanediol and diethylene glycol. Other examples of low molecular weight glycols that may be used include alkoxylated hydroquinone (e.g. HQEE from Arch Chemicals), alkoxylated resorcinol (e.g. HER from Indspec), and oligomers of ethylene oxide, propylene oxide, oxetane or tetrahydrofuran.

To prepare isocyanate-terminated polyurethane prepolymers, at least a slight excess of the isocyanate equivalents (NCO groups) with respect to the hydroxyl equivalents (OH groups) is employed to terminate the polycaprolactone polyol and/or copolymer(s) and the glycol (s) with isocyanate groups. Advantageously, the molar ratio of NCO to OH is from about 1.1 to about 16.0 depending on the selection of the particular hydroxyl-terminated polyol and/or copolymer(s) and the glycol (s).

Preparation of the prepolymers comprises adding the polyol(s) or polyol blend(s) and the glycol (s) to polyisocyanate monomer, e.g., toluene diisocyanate and maintaining the temperature from room temperature to temperatures as high as 150° C. for times necessary to react all the available hydroxyl groups. Preferred reaction temperatures are 40° C. to 110° C.; more preferred are 50° C. to 85° C. The product is transferred into containers under nitrogen flush. The excess free polyisocyanate monomer may optionally be removed using methods described in U.K. Patent No. 1,101,410 and in U.S. Pat. Nos. 5,703,193, 4,061,662, 4,182,825, 4,385,171, 4,888,442 and 4,288,577, the contents all of which are incorporated herein by reference.

The curative used for the prepolymer can be selected from a wide variety of conventional and well known organic diamine or polyol materials. In one embodiment of the invention, the curative(s) used for the prepolymer are aromatic diamines which are either low melting solids or liquids. In another embodiment of the invention, the curative(s) used for the prepolymer are diamines or polyols that are flowable below 130° C. If the melting point is above 130° C., then plasticizers may be used to lower the effective melting point of the curative. These diamines or polyols are generally the present ones used in the industry as curatives for polyurethane. The selection of a curative is generally based on reactivity needs, or property needs for a specific application, process condition needs, and pot life desired. Of course, known catalysts may be used in conjunction with the curative.

Representative curative materials include: 4,4′-methylene-bis(3-chloro)aniline (MBCA), 4,4′-Methylene dianiline (MDA), salt complexes of 4,4′-MDA e.g., Caytur 31, Caytur 31 DA, Caytur 21 and Caytur 21 DA from Chemtura Corporation, 4,4′-methylene-bis(3-chloro-2,6-diethyl)aniline (MCDEA), 4,4′-methylene-bis(2,6-diethyl)aniline (MDEA), isomers of phenylene diamine, diethyl toluene diamine (DETDA), tertiary butyl toluene diamine (TBTDA), dimethylthio-toluene diamine (Ethacure™ 300) from Albemarle Corporation, trimethylene glycol di-p-aminobenzoate (Vibracure A157) from Chemtura Corporation, and 1,2-bis(2-aminophenylthio)ethane. In one particular embodiment of the invention, the curatives are MBCA and salt complexes of 4,4′-MDA.

For curing the prepolymers, the number of —NH₂ groups in the aromatic diamine component should be approximately equal to the number of —NCO groups in the prepolymer. A small variation is permissible but in general from about 70 to about 125% of the stoichiometric equivalent should be used, preferably about 85 to about 115%.

Polyurethane elastomers with good physical and dynamic properties can be obtained by reacting the isocyanate-terminated polycaprolactone prepolymers, which are the reaction product of toluene diisocyanate and polycaprolactone polyol possessing preferably from about 300 to about 4000 molecular weight (number average M.W.) and glycol possessing a molecular weight of about 62 to about 300, with an amine chain extender at an equivalent ratio (the ratio of the reactive amine groups to the reactive isocyanate groups) of about 0.75 to about 1.15:1.

Polyurethane foams can be produced by reacting the isocyanate terminated polycaprolactone prepolymers with compounds containing two or more active hydrogens, optionally in the presence of catalysts. The catalysts are typically organometallic compounds, organo-nitrogen-containing compounds such as tertiary amines, carboxylic acids, and mixtures thereof. The active hydrogen-containing compounds are typically water, polyols, primary and secondary polyamines. Water will react with available isocyanate groups to generate carbon dioxide gas to generate the foam cells. Polyurethane foams can also be produced using blowing agents such as a low boiling organics (b.p. below about 150° C.), by entraining an inert gas such as nitrogen, air or carbon dioxide, or by using heat activated expandable polymeric microparticles incorporating such a blowing agent as exemplified the EXPANCEL® products manufactured by AKZO NOBEL. Foam preparation is described in U.S. Pat. No. 6,395,796 to Ghobary, et al, which is incorporated herein by reference.

Methods for producing polyurethane foam from the polyurethane foam forming composition of the present invention are not particularly limited. Various methods commonly used in the art may be employed. For example, various methods described in “Polyurethane Resin Handbook,” by Keiji Iwata, Nikkan Kogyo Shinbun, Ltd., 1987 may be used.

### List of Materials and Description

Adiprene LF 600D: a TDI terminated polyether prepolymer, manufactured by Chemtura Corporation, with reduced free TDI content (<0.1%) due to the monomer removal step in manufacture. There is no low molecular weight glycol used in this prepolymer. Curing with MBCA yields a high performance 60 Shore D hardness (60D) elastomer. The polyether polyol used to prepare this prepolymer is polytetramethylene ether glycol (PTMEG or PTMG), e.g. Terathane from Invista. The isocyanate (NCO) content of the prepolymer is about 7.2% and the equivalent weight is about 583. Thus, about 583 g of this prepolymer contains one mole (42 g) of NCO end groups.

Adiprene LF 601D: a TDI terminated polyether prepolymer, manufactured by Chemtura Corporation, with reduced free TDI content (<0.1%) due to the monomer removal step in manufacture. Low molecular weight glycol is used in this prepolymer, in contrast with Adiprene LF 600D as described above. Curing with MBCA yields a high performance 60 Shore D hardness (60D) elastomer. The polyether polyols used to prepare this prepolymer are polytetramethylene ether glycol (PTMEG or PTMG), e.g. Terathane from Invista and Diethylene glycol (DEG). The isocyanate (NCO) content of the prepolymer is about 7.2% and the equivalent weight is about 583. Thus, about 583 g of this prepolymer contains one mole (42 g) of NCO end groups.

Properties of cured elastomers from Adiprene LF600D and Adiprene LF601D are similar, as seen in Table 1, despite the fact that low M.W. glycol is used in LF601D and not in LF600D.

Adiprene LF 900A: a TDI terminated polyether prepolymer, manufactured by Chemtura Corporation, with reduced free TDI content (<0.1%) due to the monomer removal step in manufacture. There is no low molecular weight glycol used in this prepolymer. Curing with MBCA yields a high performance 90 Shore A hardness (90A) elastomer. The polyether polyol used to prepare this prepolymer is polytetramethylene ether glycol (PTMEG or PTMG), e.g. Terathane from Invista. The isocyanate (NCO) content of the prepolymer is about 3.8% and the equivalent weight is about 1105. Thus, about 1105 g of this prepolymer contains one mole (42 g) of NCO end groups.

Adiprene LF 1900A: a TDI terminated polyester prepolymer, manufactured by Chemtura Corporation, with reduced free TDI content (<0.1%) due to the monomer removal step in manufacture. There is no low molecular weight glycol used in this prepolymer. Curing with MBCA yields a high performance 92 Shore A hardness (92A) elastomer. The polyester polyol used to prepare this prepolymer is polyethylene adipate glycol (PEAG). The isocyanate (NCO) content of the prepolymer is about 4.2% and the equivalent weight is about 1000. Thus, about 1000 g of this prepolymer contains one mole (42 g) of NCO end groups.

Vibrathane 6060: a TDI terminated polycaprolactone prepolymer, manufactured by Chemtura Corporation, without the monomer removal step in manufacture. There is no low molecular weight glycol used in this prepolymer. Curing with MBCA yields a 62 Shore A hardness (62A) elastomer. The polyol used to prepare this prepolymer is polycaprolactone polyol (PCL). The isocyanate (NCO) content of the prepolymer is about 3.35% and the equivalent weight is about 1255. Thus, about 1255 g of this prepolymer contains one mole (42 g) of NCO end groups.

Vibrathane 8080: a TDI terminated polyester prepolymer, manufactured by Chemtura Corporation, without the monomer removal step in manufacture. There is no low molecular weight glycol used in this prepolymer. Curing with MBCA yields a 80 Shore A hardness (80A) elastomer. The polyester polyol used to prepare this prepolymer is PEPAG (polyethylene propylene adipate). The isocyanate (NCO) content of the prepolymer is about 3.3% and the equivalent weight is about 1273. Thus, about 1273 g of this prepolymer contains one mole (42 g) of NCO end groups.

Vibrathane B602: a TDI terminated polyether prepolymer, manufactured by Chemtura Corporation, without the monomer removal step in manufacture. There is no low molecular weight glycol used in this prepolymer. Curing with MBCA yields a 82 Shore A hardness (82A) elastomer. The polyether polyol used to prepare this prepolymer is PTMEG. The isocyanate (NCO) content of the prepolymer is about 3.11% and the equivalent weight is about 1351. Thus, about 1351 g of this prepolymer contains one mole (42 g) of NCO end groups.

Tone 2241: a Neopentyl glycol (NPG) initiated polycaprolactone polyol manufactured by Dow Chemical. The equivalent weight is about 1000. Thus, about 1000 g of this polyol contains one mole (17 g) of OH end groups. M.W. is about 2000.

Tone 2221: a Neopentyl glycol (NPG) initiated polycaprolactone polyol manufactured by Dow Chemical. The equivalent weight is about 500. Thus, about 500 g of this polyol contains one mole (17 g) of OH end groups. M.W. is about 1000.

Tone 1241: a Butane diol (BDO) initiated polycaprolactone polyol manufactured by Dow Chemical. The equivalent weight is about 1000. Thus, about 1000 g of this polyol contains one mole (17 g) of OH end groups. M.W. is about 2000.

Diethylene glycol (DEG): a low molecular weight glycol manufactured by Shell chemicals. The equivalent weight of DEG is 53. Thus, about 53 grams of DEG contains one mole (17 g) of OH end groups. M.W. is 106.

1,3 Butylene glycol: is a low molecular weight glycol manufactured by Hoechst-Celanese. This is an isomer of 1,4 Butane diol. The equivalent weight of 1,3 Butylene glycol (1,3 BG) is 45. Thus, about 45 grams of 1,3 BG contains one mole (17 g) of OH end groups. M.W is 90.

Mondur TD: 2,4:2,6-toluene diisocyanate (TDI) manufactured by Bayer. The equivalent weight of TDI is 87.1. Thus, about 87.1 g of TDI contains one mole (42 g) of NCO end groups. M.W. 174. Mondur TD contains about 66% by weight of the 2,4-isomer of TDI and about 34% by weight of the 2,6-isomer of TDI.

Vibracure A133(MBCA): is 4,4′-Methylene bis(2-choloroaniline) or MBCA from Chemtura Corporation. The equivalent weight of MBCA is about 133.5. Thus about 133.5 g of MBCA contains one mole (16 g) of amine end groups.

Caytur 21-DA: is a blocked delayed action amine curative from Chemtura Corporation for use with isocyanate terminated urethane prepolymers. It consists of a complex of methylene dianiline and sodium chloride dispersed in a plasticizer (Dioctyl Adipate). Caytur 21-DA has 60% active solids dispersed in DOA. Amine group concentration is 7.72%, Hence the equivalent weight is 183. At room temperature it reacts very slowly with terminal isocyanate groups of prepolymers. However at 100° C.-150° C., the salt unblocks and the freed MDA reacts rapidly with the prepolymer to form the elastomer. It yields urethane with similar properties to urethanes cured with MBCA. Suitable grades of prepolymers are available to provide a full range of hardness from 79A to 62D using Caytur as curative.

Examples have been set forth below for the purpose of illustration. The scope of the invention is not to be in any way limited by the examples set forth herein.

### COMPARATIVE EXAMPLE A

(TDI/PTMEG prepolymer without glycol): MBCA was melted on a hot plate and stored in an oven at 115° C. Adiprene LF 600D prepolymer (7.2% reactive isocyanate content) was heated to 60° C. and degassed in a vacuum chamber. MBCA was added to the prepolymer and mixed using a Flack Tek, Inc. mixer for one minute. The ratio of amine groups to isocyanate groups was 0.95 by equivalents in this example and all other examples unless noted otherwise. The mix was poured into hot metal molds at 100° C. and cured overnight in a 100° C. oven. The properties from the technical data sheet are displayed in Table 1.

### COMPARATIVE EXAMPLE B

(TDI/PTMEG prepolymer with glycol): Comparative Example A is followed with the exception that Adiprene LF 601D (7.2% reactive isocyanate content) is used instead of Adiprene LF 600D.

The physical properties of elastomers from Adiprene LF600D and Adiprene LF601D are presented in Table 1. Elastomer from Adiprene LF 600D (no low molecular weight glycol) has better dynamic properties (lower tangent delta) than elastomer from Adiprene LF 601D. Other properties are similar.

TABLE 1

| | | Material: | |
|---|---|---|---|
| | | | Comparative |
| | | Comparative | Example B |
| | | Example A | (Adiprene LF |
| | | (Adiprene LF 600D) | 601D) |
| NCO, % | | 7.2 | 7.2 |
| Processing temp. (° C.) | | 60 | 60 |
| | ASTM | | |
| Physical Property | method | | |
| Hardness Shore D | D2240 | 60 | 60 |
| Tensile, psi | D412 | 6700 | 7000 |
| Elongation, % | D412 | 290 | 290 |
| 100% Mod psi | D412 | 3600 | 3700 |
| 300% Mod psi | D412 | 4800 | 4700 |
| Split Tear, lb./in | D470 | 115 | 115 |
| (kN/m) | | | |
| Die C Tear, lb./in | D624 | 600 | 630 |
| (kN/m) | | | |
| Bashore Rebound, % | D2632 | 40 | 42 |
| Compression Set % | D395-B | 28 | 28 |
| (Method B) 22 hours | | | |
| @ 158° F. (70° C.) | | | |
| COMPRESSIVE MOD., | | | |
| PSI THIRD CYCLE | | | |
| 5% | D575 | 1000 | 1000 |
| 10% | | 1650 | 1600 |
| 15% | | 2300 | 2200 |
| 20% | | 3100 | 2900 |
| 25% | | 4000 | 4000 |
| TANGENT DELTA @ | | 0.014 | 0.017 |
| 150° C. | | | |
| Specific Gravity | D792 | 1.16 | 1.16 |

### COMPARATIVE EXAMPLE C

This example illustrates the preparation of a low free monomer prepolymer consisting of a) TDI and b) Neopentyl glycol (NPG) initiated polycaprolactone polyol of molecular weight 2000. This example also illustrates the physical properties of TDI terminated polycaprolactone prepolymer cured with Methylene bis orthochloro aniline (MBCA).

Synthesis of TDI polycaprolactone prepolymer: A prepolymer was prepared under nitrogen in a reactor by slowly adding, with stirring 0.79 parts by weight of NPG initiated polycaprolactone polyol of molecular weight 2000 at 70° C. to 0.21 parts by weight of TDI (Mondur TD, isomer ratio 65:35 2,4:2,6) at 30° C. The equivalent ratio of isocyanate group to hydroxyl groups was 3:1. The exotherm was controlled by adding polyol in two shots to avoid increase of temperature over 65° C. The reaction was continued for 3 hours at 60±5° C. The product was poured into containers under nitrogen flush and stored at 70° C. overnight to prevent solidification. The excess TDI monomer was removed using a wiped film evaporator. After 16 hours the percent isocyanate is determined. The reactive isocyanate content of the prepolymer was 3.26% NCO.

Processing of TDI polycaprolactone prepolymer: MBCA was melted on a hot plate and stored in an oven at 115° C. The TDI polycaprolactone prepolymer was heated to 85° C. and degassed in a vacuum chamber. MBCA was added to the prepolymer and mixed using a Flack Tek mixer for one minute. The ratio of amine groups to isocyanate groups was 0.95. The mix was poured into hot metal molds at 100° C. and cured overnight in a 100° C. oven. The properties are displayed in Table 2.

### COMPARATIVE EXAMPLE D

Comparative Example C was duplicated with the exception that Butane diol (BDO) initiated polycaprolactone polyol of molecular weight 2000 was used instead of NPG initiated polycaprolactone polyol. The equivalent ratio of isocyanate group to hydroxyl groups was 3:1. The NCO was 3.26%. The properties are displayed in Table 2.

### COMPARATIVE EXAMPLE E

Comparative Example C was duplicated with the exception that NPG initiated polycaprolactone polyol of molecular weight 1000 was used instead of NPG initiated polycaprolactone polyol of molecular weight 2000. The equivalent ratio of isocyanate group to hydroxyl groups was 3:1. The NCO was 5.68%. The properties are presented in Table 2.

### COMPARATIVE EXAMPLE F

Comparative Example C was duplicated with the exception that a blend of NPG initiated polycaprolactone polyol of molecular weight 2000 and NPG initiated polycaprolactone polyol of molecular weight 1000 was used. The equivalent ratio of isocyanate group to hydroxyl groups was 3:1. The NCO was 5.68%. The properties are displayed in Tables 2 and 3.

The physical properties of various TDI/Polycaprolactone prepolymers cured with MBCA are displayed in Table 2.

### COMPARATIVE EXAMPLE G

Comparative Example A was followed with the exception that Adiprene LF 900A (3.8% reactive isocyanate content) was used instead of Adiprene LF 600D. The properties of Comparative Example G are displayed in Table 3.

### COMPARATIVE EXAMPLE H

Comparative Example A was followed with the exception that Adiprene LF 1900A (4.2% reactive isocyanate content) was used instead of Adiprene LF 600D. The properties of Comparative Example H are displayed in Table 3.

As presented in Table 3, prior art TDI polycaprolactone prepolymer cured with MBCA has lower physical properties compared to TDI prepolymer from PTMEG (Adiprene LF 900A) and TDI prepolymer from adipate polyester (Adiprene LF 1900A). Comparative Examples G and H show the deficiency of TDI terminated polycaprolactone prepolymers without the presence of low molecular weight glycol. These elastomers are soft compared with those from PTMEG or PEAG. Bashore resilience and tear strength are low. Tangent Delta (Hysteresis) at 130° C. is high, indicating likely overheating in demanding dynamic applications.

The physical properties of TDI/Polycaprolactone based elastomers are compared with those of Adiprene LF 900A and Adiprene LF 1900A as presented in Table 3.

TABLE 2

| | | | | | Comparative |
|---|---|---|---|---|---|
| | | Comparative | Comparative | Comparative | Example F |
| | | Example C | Example D | Example E | (LF |
| | | (LF | (LF | (LF | TDI/PCL 2000 |
| | | TDI/PCL | TDI/PCL | TDI/PCL | (NPG initiated) + |
| | | 2000 (BDO | 2000 (NPG | 1000 (NPG | PCL 1000 |
| Material: | | initiated)) | initiated)) | initiated)) | (NPG initiated)) |
| NCO, % | | 3.26 | 3.26 | 5.68 | 4.3 |
| Processing temp. (° C.) | | 85 | 85 | 85 | 85 |
| Physical | ASTM | | | | |
| Properties | method | | | | |
| Hardness | D2240 | 62 | 94 | 89 | 85 |
| Shore A | | | | | |
| Drop Ball | | 28 | 31 | 22 | 23 |
| Resilience % | | | | | |
| Tensile, psi | D412 | 3900 | 7700 | 6350 | 5565 |
| Elongation,% | D412 | 465 | 325 | 350 | 406 |
| 100% Mod psi | D412 | 285 | 1635 | 900 | 668 |
| Split Tear, | D470 | 46 | 116 | 69 | 66 |
| lb./in (kN/m) | | | | | |
| Trouser Tear, | D1938 | 100 | 230 | 122.5 | 101 |
| lb/in (kN/m) | | | | | |
| Die C Tear, | D624 | 220 | 440 | 298 | 292 |
| lb./in (kN/m) | | | | | |
| Bashore | D2632 | 32 | 28 | 24 | 25 |
| Rebound, % | | | | | |
| COMPRESSIVE | | | | | |
| MOD., PSI | | | | | |
| THIRD CYCLE | | | | | |
| 5% | D575 | 3 | 152 | 110 | 86 |
| 10% | | 80 | 497 | 298 | 218 |
| 15% | | 134 | 764 | 472 | 343 |
| 20% | | 197 | 1078 | 658 | 488 |
| 25% | | 269 | 1682 | 908 | 671 |
| TANGENT | | — | 0.075 | — | — |
| DELTA @ 130° C. | | | | | |

TABLE 3

| | | Material: | | |
|---|---|---|---|---|
| | | Comparative | | |
| | | Example F | | |
| | | LF TDI/PCL | | |
| | | 2000 (NPG | | |
| | | initiated) + | Comparative | Comparative |
| | | PCL 1000 | Example G | Example H |
| | | (NPG | Adiprene LF | Adiprene LF |
| | | initiated | 900A | 1900A |
| NCO, % | | 4.3 | 3.8 | 4.2 |
| Processing temp. (° C.) | | 85 | 85 | 85 |
| | ASTM | | | |
| Physical Property | method | | | |
| Hardness Shore A | D2240 | 85 | 89 | 92 |
| Tensile, psi | D412 | 5565 | 4100 | 7200 |
| Elongation, % | D412 | 406 | 450 | 525 |
| 100% Mod psi | D412 | 668 | 1000 | 1200 |
| 300% Mod psi | D412 | 1534 | 1700 | 2200 |
| Split Tear, lb./in | D470 | 66 | 65 | 135 |
| (kN/m) | | | | |
| Die C Tear, lb./in | D624 | 292 | 370 | 600 |
| (kN/m) | | | | |
| Bashore Rebound, | D2632 | 25 | 50 | 27 |
| % | | | | |
| Compression Set % | D395-B | 19.2 | 25 | 32 |
| (Method B) | | | | |
| 22 hours | | | | |
| @ 158° F. (70° C.) | | | | |
| COMPRESSIVE | | | | |
| MOD., PSI | | | | |
| THIRD CYCLE | | | | |
| 5% | D575 | 86 | 210 | 240 |
| 10% | | 218 | 350 | 380 |
| 15% | | 343 | 490 | 525 |
| 20% | | 488 | 680 | 720 |
| 25% | | 671 | 940 | 970 |
| TANGENT | | — | 0.016 | 0.018 |
| DELTA @ 130° C. | | | | |

### COMPARATIVE EXAMPLE I

Comparative Example A was followed with the exception that Vibrathane 6060 (3.35% reactive isocyanate content) was used instead of Adiprene LF 600D. The hardness (Shore A) and tangent delta (@ 130° C.) of Comparative Example I are compared with Example 3 and are displayed in Table 4. The elastomer was post cured at room temperature for 1 week.

### COMPARATIVE EXAMPLE J

Low Molecular Weight Glycol In Curative, Not Prepolymer: MBCA was melted on a hot plate and stored in an oven at 115° C. Vibrathane 6060 prepolymer (3.35% reactive isocyanate content) was heated to 60° C. and degassed in a vacuum chamber. A blend of Diethylene glycol and MBCA was prepared in 43/57 ratio. This was to ensure that the same amount of DEG was present in the prepolymer as in Example 1 and 3. The curative blend was added to the prepolymer and mixed using a Flack Tek, Inc. mixer for one minute. The ratio of amine groups to isocyanate groups was 0.95 by equivalents. The mix was poured into hot metal molds at 100° C. and cured overnight in a 100° C. oven. The hardness (Shore A) and tangent delta (@ 130° C.) of Comparative Example J are compared with Example 3 and are displayed in Table 4. The elastomer was post cured at room temperature for 1 week.

### COMPARATIVE EXAMPLE K

Caytur 31 DA was rolled overnight to ensure adequate dispersion of solids in the plasticizer. Vibrathane 6060 prepolymer (3.35% reactive isocyanate content) was heated to 60° C. and degassed in a vacuum chamber. Caytur 31 DA was added to the prepolymer and mixed using a Flack Tek, Inc. mixer for one minute. The ratio of amine groups to isocyanate groups was 0.95 by equivalents. The mix was poured into hot metal molds at 115° C. and cured overnight in a 115° C. oven. The hardness (Shore A) and tangent delta (@ 130° C.) of Comparative Example K are compared with Example 4 and are displayed in Table 4. The elastomer was post cured at room temperature for 1 week.

### EXAMPLE 1

This example illustrates the preparation of a low free monomer prepolymer consisting of a) TDI b) Neopentyl glycol (NPG) initiated polycaprolactone polyol of molecular weight 2000 and c) Diethylene glycol (DEG) of molecular weight 106. This example also illustrates the physical properties of TDI terminated polycaprolactone prepolymer cured with Methylene bis orthochloro aniline (MBCA).

Synthesis of TDI polycaprolactone prepolymer: A prepolymer was prepared under nitrogen in a reactor by slowly adding, with stirring 0.72 parts by weight of NPG initiated polycaprolactone polyol at 70° C. to 0.26 parts by weight of TDI at 30° C., 0.02 parts by weight of Diethylene glycol was added to the reactor at 55° C. The exotherm was controlled by adding polyol in two shots and DEG in two shots to avoid increase of temperature over 65° C. The reaction was continued for 3 hours at 60±5° C. The equivalent ratio of isocyanate group to hydroxyl groups was 3:1. The product was poured into containers under nitrogen flush and stored at 70° C. overnight to prevent solidification. The excess TDI monomer was removed using a wiped film evaporator. The reactive isocyanate content (NCO) of the prepolymer was 4.3%.

Processing of TDI polycaprolactone prepolymer: MBCA was melted on a hot plate and stored in an oven at 115° C. The TDI polycaprolactone prepolymer was heated to 85° C. and degassed in a vacuum chamber. MBCA was added to the prepolymer and mixed using a Flack Teck mixer for one minute. The ratio of amine groups to isocyanate groups was 0.95. The mix was poured into hot metal molds at 100° C. and cured overnight in a 100° C. oven. The properties are presented in Table 5.

### EXAMPLE 2

Example 1 was duplicated with the exception that 1,3 Butylene glycol (BG) of molecular weight 90 is used instead of DEG. The prepolymer was synthesized with 0.723 parts by weight NPG initiated Polycaprolactone prepolymer, 0.013 parts by weight of BG and 0.264 parts by weight TDI. The equivalent ratio of isocyanate group to hydroxyl groups was 3:1. The NCO was 4.3%. The properties are presented in Table 5.

### EXAMPLE 3

Example 1 was duplicated with the exception that the equivalent ratio of isocyanate group to hydroxyl groups was 2:1. The NCO was 3.68%. The hardness (Shore A) and tangent delta (@130° C.) are displayed in Table 4. The elastomer was post cured at room temperature for 1 week. Longer post cure will yield better elastomers.

### EXAMPLE 4

Example 1 was duplicated with the exception that the curative used was Caytur 31 DA. Caytur 31 DA was rolled overnight to ensure adequate dispersion of solids in the plasticizer. The prepolymer prepared as described in Example 3 (3.68% reactive isocyanate content) was heated to 60° C. and degassed in a vacuum chamber. Caytur 31 DA was added to the prepolymer and mixed using a Flack Tek, Inc. mixer for one minute. The ratio of amine groups to isocyanate groups was 0.95 by equivalents. The mix was poured into hot metal molds at 115° C. and cured overnight in a 115° C. oven. The hardness (Shore A) and tangent delta (@ 130° C.) are displayed in Table 4. The elastomer was post cured at room temperature for 1 week. Longer post cure will yield better elastomers.

As presented in Tables 2, 4 and 5 the Shore A hardness and other mechanical properties of TDI polycaprolactone prepolymers dramatically increase with the presence of a lower molecular weight glycol. This is unique to TDI terminated polycaprolactone prepolymers as can be seen from Comparative Example A, B and G which describe TDI/Polyether and TDI/Polyester compositions. Addition of the low molecular weight glycol to the curative does not impart these improvements. The low molecular weight glycol must be a component of the isocyanate-terminated prepolymer.

The physical properties of TDI/Polycaprolactone based elastomers without and with low molecular weight glycol are presented in Table 5. Each property cited reflects an improvement in the elastomer formed from prepolymer that was formed in part from low molecular weight glycol.

TABLE 4

| | Example 3 | Comparative | Comparative | Example 4 | Comparative |
|---|---|---|---|---|---|
| | (LF TDI/PCL | Example I | Example J | (LF TDI/PCL | Example K |
| | 2000 + DEG)/ | Vibrathane | Vibrathane | 2000 + DEG) | Vibrathane 6060/ |
| Material | MBCA | 6060/MBCA | 6060/MBCA + DEG | Caytur 31 DA | Caytur 31 DA |
| Hardness | 86A | 59A | 51A | 84A | 60A |
| (Shore A) | | | | | |
| Tangent | 0.013 | 0.037 | 0.033 | 0.02 | 0.075 |
| Delta | | | | | |
| (@ 130° C.) | | | | | |

TABLE 5

| | | Material: | | |
|---|---|---|---|---|
| | | Comparative | Example 2 | |
| | | Example F | LF | Example 1 |
| | | LF TDI/PCL 2000 | TDI/PCL | LF |
| | | (NPG initiated) + PCL | 2000 (NPG | TDI/PCL |
| | | 1000 (NPG | initiated) + 1.3 | 2000 (NPG |
| | | initiated) | BG | initiated) + DEG |
| NCO, % | | 4.3 | 4.3 | 4.3 |
| Processing temp. (° C.) | | 85 | 85 | 85 |
| | ASTM | | | |
| Physical Property | method | | | |
| Hardness Shore A | D2240 | 85 | 89 | 92 |
| Drop Ball Resilience % | | 23 | 38 | 42 |
| Tensile, psi | D412 | 5565 | 6900 | 6920 |
| Elongation, % | D412 | 406 | 410 | 410 |
| 100% Mod psi | D412 | 668 | 880 | 1075 |
| 300% Mod psi | D412 | 1534 | 2115 | 2485 |
| Split Tear, lb./in (kN/m) | D470 | 66 | 74.1 | 102 |
| Trouser Tear, lb/in | D1938 | 101 | 131.4 | 153 |
| (kN/m) | | | | |
| Die C Tear, lb./in (kN/m) | D624 | 292 | 333 | 545 |
| Bashore Rebound, % | D2632 | 25 | 32 | 34 |
| Compression Set % | D395-B | 19.2 | 17.1 | 16.8 |
| (Method B) 22 hours @ | | | | |
| 158° F. (70° C.) | | | | |
| COMPRESSIVE | | | | |
| MOD., PSI THIRD CYCLE | | | | |
| 5% | D575 | 86 | 118 | 173 |
| 10% | | 218 | 305 | 383 |
| 15% | | 343 | 467 | 564 |
| 20% | | 488 | 643 | 778 |
| 25% | | 671 | 880 | 1066 |
| TANGENT DELTA @ 130° C. | | — | 0.016 | 0.019 |

While the process of the invention has been described with reference to certain embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out the process of the invention but that the invention will include all embodiments falling within the scope of the appended claims.

What is claimed is:

1. A prepolymer composition comprising the reaction product of:
a) at least one organic polyisocyanate;
b) at least one polycaprolactone-based polyol possessing a number average molecular weight of from about 300 to about 10,000;
c) at least one glycol possessing a number average molecular weight of not greater than about 300; and, optionally,
d) at least one additional polyol.

2. The prepolymer composition of claim 1 wherein the free polyisocyanate monomer content has been reduced by distillation to less than about 2% percent by weight of the polyurethane prepolymer

3. The prepolymer composition of claim 1 wherein the free polyisocyanate monomer content has been reduced by distillation to less than about 0.5% percent by weight of the polyurethane prepolymer

4. The prepolymer composition of claim 1 wherein the free polyisocyanate monomer content has been reduced by distillation to less than about 0.1% percent by weight of polyurethane prepolymer.

5. The prepolymer composition of claim 1 wherein the polycaprolactone polyol possesses the general formula:
H(OCH₂CH₂CH₂CH₂CH₂O)ₘOIO(OCH₂CH₂CH₂CH₂CH₂O)ₙH;
wherein m and n are integers large enough that the polycaprolactone polyol has a number average molecular weight of from about 300 to about 10,000, and I is a hydrocarbon moiety or an organic moiety possessing ether or ester linkages.

6. The prepolymer composition of claim 5 wherein the polycaprolactone-based polyol is prepared by addition polymerization of an epsilon-caprolactone with a polyhydroxyl compound initiator.

7. The prepolymer composition of claim 1 wherein the polyisocyanate is at least one member selected from the group consisting of MDI and TDI.

8. The prepolymer composition of claim 7 wherein the polyisocyanate is at least one selected from the group consisting of isomers of toluene diisocyanate, diphenylmethane isocyanate and polymeric versions thereof.

9. The prepolymer composition of claim 1 wherein the glycol is selected from the group consisting of ethylene glycol, isomers of propanediol, butanediol, pentanediol, hexanediol, and mixtures thereof.

10. The prepolymer composition of claim 9 wherein the glycol is selected from the group consisting of diethylene glycol, 1,3 butylene glycol and mixtures thereof.

11. The prepolymer composition of claim 1 wherein the additional polyol is at least one selected from the group consisting of polyether polyol, polyester polyol, polyetherester polyols, polyesterether polyols, polybutadiene polyols, acrylic component-added polyols, acrylic component-dispersed polyols, styrene-added polyols, styrene-dispersed polyols, vinyl-added polyols, vinyl-dispersed polyols, urea-dispersed polyols, polycarbonate polyols, polyoxyalkylene diols, polyoxyalkylene triols, and polytetramethylene glycols.

12. A wheel or tire comprising the elastomer formed by curing the prepolymer composition of claim 1 with a curative comprising methylene bis(orthochloroaniline) and/or a salt complex of 4,4′ methylenedianiline.

13. A roll comprising the elastomer formed by curing the prepolymer composition of claim 1 with a curative comprising methylene bis(orthochloroaniline) and/or a salt complex of 4,4′ methylenedianiline.

14. A belt comprising the elastomer formed by curing the prepolymer composition of claim 1 with a curative comprising methylene bis(orthochloroaniline) and/or a salt complex of 4,4′ methylenedianiline.

15. A seal or gasket comprising the elastomer formed by curing the prepolymer composition of claim 1 with a curative comprising methylene bis(orthochloroaniline) and/or a salt complex of 4,4′ methylenedianiline.

16. A screen comprising the elastomer formed by curing the prepolymer composition of claim 1 with a curative comprising methylene bis(orthochloroaniline) and/or a salt complex of 4,4′ methylenedianiline.

17. An elastomer comprising the reaction product of the prepolymer composition of claim 1 with a curative comprising methylene bis(orthochloroaniline) and/or a salt complex of 4,4′ methylenedianiline.

18. An elastomer comprising the reaction product of the prepolymer composition of claim 2 with a curative comprising methylene bis(orthochloroaniline) and/or a salt complex of 4,4′ methylenedianiline.

19. An elastomer comprising the reaction product of the prepolymer composition of claim 3 with methylene bis(orthochloroaniline) and/or a salt complex of 4,4′ methylenedianiline.

20. An elastomer comprising the reaction product of the prepolymer composition of claim 4 with methylene bis(orthochloroaniline) and/or a salt complex of 4,4′ methylenedianiline.

21. A polyurethane foam-forming composition comprising:
i) an isocyanate terminated prepolymer formed from;
a) at least one polycaprolactone polyol possessing a number average molecular weight of from about 300 to about 10,000;
b) at least one polyisocyanate;
c) at least one glycol possessing a number average molecular weight of not greater than about 300; and, optionally,
d) at least one additional polyol;
ii) at least one blowing agent selected from the group consisting of water, air, nitrogen, carbon dioxide, organics with boiling temperature below about 150° C., and preformed polymeric particles possessing at least one aforementioned blowing agent; and,
iii) at least one aromatic diamine curative, or water.

22. The polyurethane foam-forming composition of claim 21 wherein the polycaprolactone polyols possess the general formula:
H(OCH₂CH₂CH₂CH₂CH₂O)ₘOIO(OCH₂CH₂CH₂CH₂CH₂O)ₙH;
wherein m and n are integers large enough that the polycaprolactone polyol has a number average molecular weight of from about 300 to about 10,000, and wherein I is a hydrocarbon moiety or an organic moiety possessing ether or ester linkages.

23. The polyurethane foam-forming composition of claim 22 wherein the polycaprolactone polyol is prepared by addition polymerization of an epsilon-caprolactone with a polyhydroxyl compound initiator.

24. The polyurethane foam-forming composition of claim 21 wherein the polyisocyanate is at least one member selected from the group consisting of MDI and TDI.

25. The polyurethane foam-forming composition of claim 24 wherein the polyisocyanate is at least one selected from the group consisting of isomers of toluene diisocyanate, diphenylmethane isocyanate and polymeric versions thereof.

26. The polyurethane foam-forming composition of claim 21 wherein at least one blowing agent is water.

27. The polyurethane foam-forming composition of claim 21 wherein at least one blowing agent is a preformed polymeric particle possessing a blowing agent.

28. The polyurethane foam-forming composition of claim 21 wherein at least one blowing agent is mechanically entrained air, nitrogen, or carbon dioxide.

29. The polyurethane foam-forming composition of claim 21 wherein at least one blowing agent is an organic liquid with boiling point below 150° C.

30. The polyurethane foam-forming composition of claim 21 wherein the polyurethane foam has a density of from about 5 to about 100 kilograms per meter³.

31. A process of manufacturing a polyurethane foam which comprises foaming the foam-forming composition of claim 21.

32. A polyurethane foam prepared by the process of claim 31.
